(19) United States
(12) Patent Application Publication
(10) Pub. No.: US 2023/0370861 A1
(43) Pub. Date: Nov. 16, 2023

(54) METHOD AND NETWORK NODE FOR SIGNALLING TCI STATES TO USER EQUIPMENT

(71) Applicant: Telefonaktiebolaget LM Ericsson (publ), Stockhlm (SE)

(72) Inventors: Magnus HURD, Stockholm (SE); Ying SUN, Täby (SE)

(21) Appl. No.: 18/033,598

(22) PCT Filed: Nov. 27, 2020
(86) PCT No.: PCT/SE2020/051138

§ 371 Date: Apr. 25, 2023

(51) Int. Cl. H04W 16/28; H04L 5/00

(52) U.S. Cl. CPC H04W 16/28; H04L 5/0051

(57) ABSTRACT

There is provided mechanisms for signalling TCI states. A method is performed by a network node. The network node is configured to control transmission of reference signals from at least two TRPs. The method includes signalling, towards user equipment is served by the network node, a sequence of TCI states defined for a reference signal burst in which the reference signals are to be transmitted from the TRPs. At least one of the TCI states in the sequence of TCI states is representative of one of the reference signals to be jointly transmitted on a beamform from a first TRP of the TRPs and on a beamform from a second TRP of the TRPs. The method includes initiating transmission of the reference signal burst from the TRPs.

### TECHNICAL FIELD Embodiments presented herein relate to a method, a network node, a computer program, and a computer program product for signalling Transmission Configuration Indicator (TCI) states.

### BACKGROUND

In communications networks, there may be a challenge to obtain good performance and capacity for a given communications protocol, its parameters and the physical environment in which the communications network is deployed.

High frequency deployment is according to the third generation partnership project (3GPP) referred to as deployments on frequency range 2 (FR2), i.e. frequencies higher than 6 GHz. To cope with the coverage challenge at such high frequency bands, the transmission and reception points (TRPs) at the network-end need to be equipped with more individual antenna elements than TRPs used for lower frequency bands. With respect to the air interface, called new radio (NR) of fifth generation (5G) telecommunication systems the notion of massive antenna arrays has therefore been introduced. Massive antenna arrays are intended to achieve both increased coverage and increased level of throughput. These antenna arrays are sometimes referred to as Advanced Antenna Systems (AAS). In 3GPP the AAS is referred to as a TRP. A TRP might comprise one or more antenna panels, where each antenna panel is composed of one or more antenna arrays with a plurality of individual antenna elements. Analog beamforming (also known as time-domain beamforming) can be used to reduce the cost of the AAS. Also the user equipment at the user-end might be configured for analog beamforming to operate at FR2. This implies that the user equipment will only be capable to receive a transmission in one beam at a time since its spatial reception filter applies to all resource elements of an orthogonal frequency-division multiplexing (OFDM) symbol (per polarization). Time-division duplexing (TDD), i.e., the application of time-division multiplexing, is used for all frequency bands in FR2.

A set of predefined beamforms Aᵢ, collectively defining a so-called Grid of Beams (GOB), could be designed to cover a certain spatial coverage region. Each such beamform would transmit a specific Synchronization Signal Block (SSB) labeled by an SSB index. Generally, there can be at most X of these SSBs, which means the SSB index ranges from 0 to X−1; for release 15 (Rel-15) of NR, X=64 for FR2.

One reason for using such narrow beam transmission and reception schemes at FR2 is to compensate the expected high propagation loss. For a given communication link, a respective beamform can be applied at both the network-end (as represented by a network node or its TRP) and at the user-end (as represented by a user equipment), which typically is referred to as a beam pair link (BPL). A BPL (i.e. both the beamform used by the network node and the beamform used by the user equipment) is expected to be discovered and monitored by the network using measurements on downlink reference signals, such as channel state information reference signals (CSI-RS) or SSB signals, used for beam management. A beam management procedure can be used for discovery and maintenance of BPLs. In some aspects, the beam management procedure is defined in terms of a P-1 sub-procedure, a P-2 sub-procedure, and a P-3 sub-procedure.

While the above beam management procedure could be used to establish a BPL to a single TRP, there could be scenarios where the user equipment could benefit from receiving transmission (such as data and/or control signalling) from also from another TRP. There could also be scenarios where the transmissions from the two or more TRPs to the user equipment occur in the same time and/or frequency resource. The above beam management procedure does not take any of these scenarios into account.

Hence, there is still a need for improved beam management procedures involving two or more TRPs communicating with the same user equipment.

### SUMMARY

An object of embodiments herein is to enable efficient beam management for the above scenarios where two or more TRPs are communicating with the same user equipment.

According to a first aspect there is presented a method for signalling TCI states. The method is performed by a network node. The network node is configured to control transmission of reference signals from at least two TRPs. The method comprises signalling, towards user equipment is served by the network node, a sequence of TCI states defined for a reference signal burst in which the reference signals are to be transmitted from the TRPs. At least one of the TCI states in the sequence of TCI states is representative of one of the reference signals to be jointly transmitted on a beamform from a first TRP of the TRPs and on a beamform from a second TRP of the TRPs. The method comprises initiating transmission of the reference signal burst from the TRPs.

According to a second aspect there is presented a network node for signalling TCI states. The network node is configured to control transmission of reference signals from at least two TRPs. The network node comprises processing circuitry. The processing circuitry is configured to cause the network node to signal, towards user equipment is served by the network node, a sequence of TCI states defined for a reference signal burst in which the reference signals are to be transmitted from the TRPs. At least one of the TCI states in the sequence of TCI states is representative of one of the reference signals to be jointly transmitted on a beamform from a first TRP of the TRPs and on a beamform from a second TRP of the TRPs. The processing circuitry is configured to cause the network node to initiate transmission of the reference signal burst from the TRPs.

According to a third aspect there is presented a network node for signalling TCI states. The network node is configured to control transmission of reference signals from at least two TRPs. The network node comprises a signal module configured to signal, towards user equipment is served by the network node, a sequence of TCI states defined for a reference signal burst in which the reference signals are to be transmitted from the TRPs. At least one of the TCI states in the sequence of TCI states is representative of one of the reference signals to be jointly transmitted on a beamform from a first TRP of the TRPs and on a beamform from a second TRP of the TRPs. The network node comprises an initiate module configured to initiate transmission of the reference signal burst from the TRPs.

According to a fourth aspect there is presented a computer program for signalling TCI states, the computer program comprising computer program code which, when run on a network node, causes the network node to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects enable efficient beam management in scenarios where the user equipment could benefit from receiving transmission (such as data and/or control signalling) from two or more TRPs.

Advantageously, these aspects enable efficient beam management in scenarios where the user equipment where the transmissions from the two or more TRPs to the user equipment occur in the same time and/or frequency resource.

Advantageously, these aspects improve the reliability for single-frequency network (SFN) transmissions using time-domain beamforming.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1, 3, and 4 are schematic diagrams illustrating a communication network according to embodiments;

FIG. 2 schematically illustrates a beam management procedure according to embodiments;

FIG. 5 is a flowchart of methods according to embodiments;

FIG. 6 is a schematic diagram showing functional units of a network node according to an embodiment;

FIG. 7 is a schematic diagram showing functional modules of a network node according to an embodiment;

FIG. 8 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

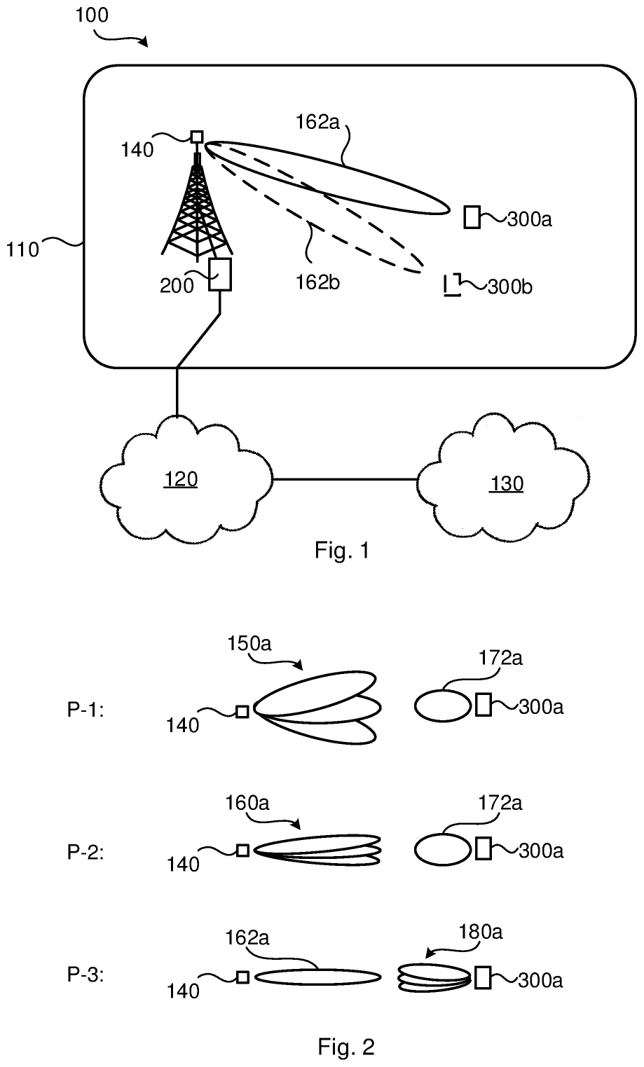

FIG. 1 is a schematic diagram illustrating a communication network 100 where embodiments presented herein can be applied. The communication network 100 could be a third generation (3G) telecommunications network, a fourth generation (4G) telecommunications network, a fifth generation (5G) telecommunications network, or any evolvement thereof, and support any 3GPP telecommunications standard, where applicable.

The communication network 100 comprises a network node 200 configured to provide network access to user equipment, as represented by user equipment 300a, in a radio access network 110. The radio access network 110 is operatively connected to a core network 120. The core network 120 is in turn operatively connected to a service network 130, such as the Internet. The user equipment 300a is thereby enabled to, via the network node 200, access services of, and exchange data with, the service network 130.

The network node 200 comprises, is collocated with, is integrated with, or is in operational communications with, at least one transmission and reception point (TRP) 140. The network node 200 (via its TRP 140) and the user equipment 300a are configured to communicate with each other in beamforms, two of which are illustrated at reference numerals 162a, 162b. In this respect, beamforms that could be used both as transmission beams and reception beams will hereinafter simply be referred to as beamforms. In this respect, user equipment 300b might either represent user equipment 300a as moved to another location or another user equipment served by the network node 200.

Examples of network nodes 200 are radio access network nodes, radio base stations, base transceiver stations, Node Bs, evolved Node Bs, gNBs, access points, access nodes, and backhaul nodes. Examples of user equipment 300a, 300b are wireless devices, terminal devices, mobile stations, mobile phones, handsets, wireless local loop phones, smartphones, laptop computers, tablet computers, wearable communication devices, network equipped sensors, network equipped vehicles, and so-called Internet of Things devices.

FIG. 2 schematically illustrates a beam management procedure consisting of three sub-procedures, referred to as P-1, P-1, and P-3 sub-procedures. These three sub-procedures will now be disclosed in more detail. For simplicity, only one user equipment 300a is illustrated in FIG. 2 but the skilled person understands that the beam management procedure could also be performed for two or more user equipment 300a, 300b.

One main purpose of the P-1 sub-procedure is for the network node 200 to find a coarse direction towards the user equipment 300a by transmitting reference signals in wide, but narrower than sector, beamforms that are swept over the whole angular sector. The TRP 140 is expected to, for the P-1 sub-procedure, utilize beamforms, according to a spatial beam pattern 150a, with rather large beam widths. During the P-1 sub-procedure, the reference signals are typically transmitted periodically and are shared between all user equipment 300a served by the network node 200 in the radio access network 110. The user equipment 300a typically use a wide, or even omni-directional beamform for receiving the reference signals during the P-1 sub-procedure, according to a spatial beam pattern 172a. The reference signals might be periodically transmitted CSI-RS (or, formally, CSI-RS resources) or SSB. The user equipment 300a might then to the network node 200 report the Y≥1 best beamforms and their corresponding quality values, such as reference signal received power (RSRP) values. The beam reporting from the user equipment 300a to the network node 200 might be performed rather seldom (in order to save overhead) and can be either periodic, semi-persistent or aperiodic.

One main purpose of the P-2 sub-procedure is to refine the beamform selection at the TRP 140 by the network node 200 transmitting reference signals whilst performing a new beam sweep with more narrow directional beamforms, according to a spatial beam pattern 160a, than those beamforms used during the P-1 sub-procedure, where the new beam sweep is performed around the coarse direction, or beamform, reported during the P-1 sub-procedure. During the P-2 sub-procedure, the user equipment 300a typically use the same beamform as during the P-1 sub-procedure, according to a spatial beam pattern 172a. The user equipment 300a might then to the network node 200 report the Y≥1 best beamforms and their corresponding quality values, such as reference signal received power (RSRP) values. One P-2 sub-procedure might be performed per each user equipment 300a or per each group of user equipment 300a. The reference signals might be aperiodically or semi-persistently transmitted CSI-RS (or, formally, CSI-RS resources). The P-2 sub-procedure might be performed more frequently than the P-1 sub-procedure in order to track movements of the user equipment 300a and/or changes in the radio propagation environment.

One main purpose of the P-3 sub-procedure is for user equipment 300a utilizing analog beamforming, or digital wideband (time domain beamformed) beamforming, to find its own best beamform. During the P-3 sub-procedure, the reference signals are transmitted, according to a spatial beam pattern 162a, in the best reported beamform of the P-2 sub-procedure whilst the user equipment 300a performs a beam sweep, according to a spatial beam pattern 180a. The P-3 sub-procedure might be performed at least as frequently as the P-2 sub-procedure in order to enable the user equipment 300a to compensate for blocking, and/or rotation.

As noted above, there is still a need for improved beam management procedures involving two or more TRPs communicating with the same user equipment 300a, 300b.

The SSBs provide the user equipment 300a with an opportunity to synchronize to, and in general access, the network. In the P-1 sub-procedure the SSBs are transmitted during an SSB burst, which is repeated with a certain periodicity. The configuration parameter ssb-PositionsInBurst transmitted in SIB1 (system information block 1) or in ServingCellConfigCommon as part of radio resource control (RRC) configuration. The configuration parameter ssb-PositionsInBurst is a bitmap signifying what indices are actually provided in the cell. Each (index of an) SSB is associated to Physical Random Access Channel (PRACH) occasions. Such an associated PRACH occasion occurs in an uplink slot. This means that the network node 200 can prepare which spatial filter to use at the TRP i40 to receive a random access preamble from the user equipment 300a according to a beamform that was previously used for the associated SSB index.

For the user equipment 300a to properly understand the transmissions from the TRP 140 on the network-end, the TRP 140 needs to transmit a set of reference signals that each represent a so-called antenna port. There are at least two purposes for transmitting reference signals: (i) to define the channel in order to support demodulation of a transmission; (ii) to prepare that transmissions are actually done in a way that fits the channel characteristics. One type of reference signal which could be used for the first purpose is demodulation reference signals (DM-RSs) supporting the estimation of the channel. One type of reference signal which could be used for the second purpose is CSI-RSs supporting the user equipment 300a to produce Channel State Information (CSI) report. The CSI reports would then form the basis for the network node 200 to construct transmissions, such as determining which beamforms to use, that fit the channel characteristics. SSBs can also be used as reference signal to support beam management; the user equipment 300a would then in the CSI report indicate a list of the strongest SSBs together with their respective reference signal received power (RSRP) value.

Generally, the level of directional dependency increases with the carrier frequency. This implies that the user equipment 300a needs to be prepared with information about what spatial properties apply to an upcoming transmission, both for downlink and for uplink. For downlink the TCI represents for the user equipment 300a a quasi co-location (QCL) relationship between the reference signal it needs to currently analyze and a downlink reference signal it has previously encountered. In essence, this makes it possible for the user equipment 300a to relate any reference signal to, for instance, one of the SSBs. If the user equipment 300a has applied a certain spatial filter successfully to receive a first reference signal, that same certain spatial filter can then be reused for later reception of a second reference signal being QCL to the corresponding first reference signal. Likewise, an uplink transmission can be said to have a spatial relation to another uplink transmission or to a downlink reception. By pointing to various spatial relations, the network node 200 can thus indicate to the user equipment 300a what spatial filter to apply for the upcoming transmission. The spatial relations could be based on the SSBs, if the user equipment 300a supports beam correspondence. Beam correspondence for a user equipment 300a means that the user equipment 300a is configured to transmit in the same direction as it has previously been receiving a transmission.

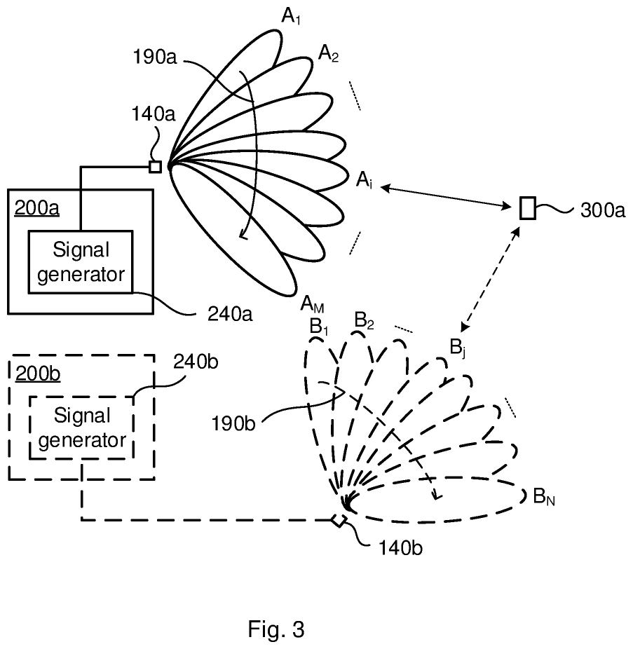

Assume now that a second TRP is introduced in the network such that there are at least two TRPs at different locations. This is illustrated in FIG. 3. FIG. 3 is a schematic diagram illustrating a communication network similar to that of FIG. 1 but comprising two TRPs 140a, 140b, each controlled by its own network node 200a, 200b. Reference signals, such as SSBs or CSI-RS are transmitted using beamformers A₁, A₂, . . . , Aᵢ, . . . , A_{M} from TRP 140a and beamformers B₁, B₂, . . . , Bⱼ, B_{N} from TRP 140b during respective beam sweeps 190a, 190b. FIG. 3 schematically illustrates an example setup with two TRPs 140a, 140b and where the user equipment 300a expects transmissions involving one TRP 140a, 140b at a time. In this case each TRP 140a, 140b has its own set of reference signals, such as SSBs, each with its own set of TCI states, as generated by a respective signal generator 240a, 240b in each of the network nodes 200a, 200b. The SSBs from each TRPs 140a, 140b are all represented by an index of the SSB burst (ssb-PositionsInBurst). The second TRP 140b could be used to transmit additional layers, each represented by its own dedicated DM-RS and each carrying different information. However, to favor reliability, a single-frequency network (SFN) would use several transmitters (or TRPs 140a, 140b) simultaneously to send the same signal over the same frequency resources. In some channel conditions, there could be outage on the link between one of the TRPs 140a, 140b and the user equipment 300a. Some physical object could, for instance, temporarily block the wireless link between the user equipment 300a and one of the TRPs 140a, 140b. That is why the second TRP 140b, located at another position than the first TRP 140a, could be used to create redundancy and hence add extra reliability for transmissions.

The SFN signal (including the DM-RS) duplicated in the transmissions from the at least TRPs 140a, 140b imitates multi-path propagation where each path is formed from a specific sequence of reflections to finally be received and accumulated at the target user equipment 300a. The accumulation of power from each path increases the likelihood for the user equipment 300a to correctly decode the transmitted symbol. Just as for multi-path propagation the power from the different links to TRPs 140a, 140b, transmitting the same complex symbol would accumulate and enable successful reception of the transmitted symbol at the user equipment 300a.

The user equipment 300a performs measurements on the SSBs to either select the most dominant SSB (i.e., the SSB for which highest RSRP was determined) for random access, or, as part of a beam management procedures, reports at least the most dominant SSB in a CSI report. If a new dominant SSB appears different than the serving one, the network node 200 indicates a switch of TCI state to the user equipment 300a. Upcoming transmissions would then be aligned to this new TCI state.

For SFN transmissions in the scenario of FIG. 3, both TRPs 140a, 140b are involved. This means that TCI states introduced per TRP 140a, 140b or SSB would not accurately represent the transmissions. A TCI state could be selected according to the most dominant TRP 140a, 140b, or SSB. However, since transmission anyway occurs from both TRPs 140a, 140b (not only the dominant one) the user equipment 300awould use a spatial filter that would only be optimized for reception from one of the TRPs 140a, 140b. This counter-acts the intention of the SFN transmission.

The embodiments disclosed herein therefore relate to mechanisms for signalling TCI states. In order to obtain such mechanisms there is provided a network node 200, a method performed by the network node 200, a computer program product comprising code, for example in the form of a computer program, that when run on a network node 200, causes the network node 200 to perform the method.

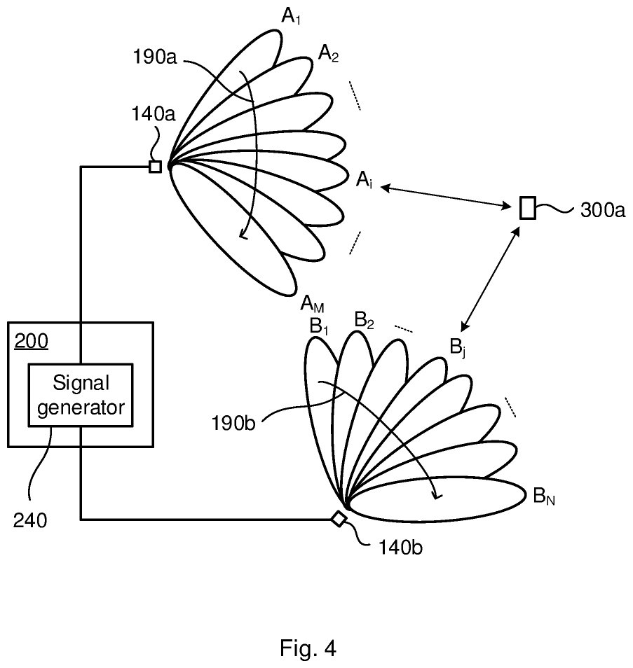

At least some of the embodiments disclosed herein are based on that instead of having reference signals, such as SSBs and CSI-RSs, and TCI states implemented strictly per TRP 300a, 300b, TCI states are introduced that represent a reference signal transmitted on a combination constructed by one beamform Aᵢ from TRP 140a and one beamform Bⱼ from TRP 140b. FIG. 4 is a schematic diagram illustrating a communication network similar to that of FIG. 2 but where the two TRPs 140a, 140b are controlled by one and the same network node 200 and where the reference signals are generated in one and the same signal generator 240 in the network node 200. In case the reference signals are SSBs, each such combination could then, for example, be represented by an index in the SSB burst (ssb-PositionsInBurst). The concept illustrated in FIG. 4 could be extended to more than two TRPs 140a, 140b, where thus all TRPs have their own set of beamforms and are controlled by one and the same network node 200.

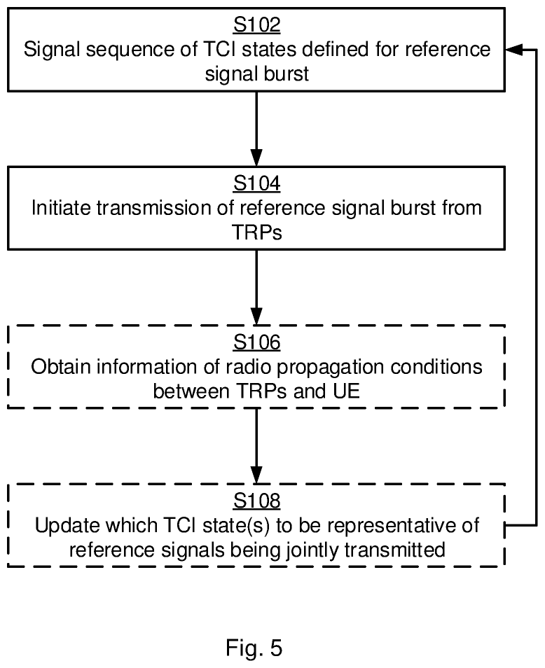

FIG. 5 is a flowchart illustrating embodiments of methods for signalling TCI states. The methods are performed by the network node 200. The network node 200 is configured to control transmission of reference signals from at least two TRPs 140a, 140b. The methods are advantageously provided as computer programs 820.

S102: The network node 200 signals, towards user equipment 300a, 300b being served by the network node 200, a sequence of TCI states. The sequence of TCI states is defined for a reference signal burst in which the reference signals are to be transmitted from the TRPs 140a, 140b. At least one of the TCI states in the sequence of TCI states is representative of one of the reference signals to be jointly transmitted on a beamform A₁:A_{M} from a first TRP 140a of the TRPs 140a, 140b and on a beamform B₁:B_{N} from a second TRP 140b of the TRPs 140a, 140b.

S104: The network node 200 initiates transmission of the reference signal burst from the TRPs 140a, 140b.

Embodiments relating to further details of signalling TCI states as performed by the network node 200 will now be disclosed.

In some embodiments, the reference signals in the reference signal burst from each of the TRPs 140a, 140b are transmitted during a beam sweep. The beam sweep is performed in a set of beamforms A₁:A_{M}, B₁:B_{N}. In each beam sweep the reference signals are sequentially transmitted, one reference signal per beamform A₁:A_{M}, B₁:B_{N} in the set of beamforms A₁:A_{M}, B₁:B_{N}.

In some embodiments, at least one of the TCI states in the sequence of TCI states is representative of that one of the reference signals is to be transmitted from only one of the TRPs 140a, 140b.

In some embodiments, the sequence of TCI states represents a sequence of spatial filters to be used by user equipment 300a, 300b for reception of the reference signals.

In some embodiments, each spatial filter corresponds to a directional beam (to be used by the user equipment 300a, 300b). Further, the at least one of the TCI states in the sequence of TCI states that is representative of the reference signal to be jointly transmitted on the beamform A₁:A_{M} from the first TRP 140a of the TRPs 140a, 140b and on the beamform B₁:B_{N} from the second TRP 140b of the TRPs 140a, 140b represents a spatial filter. The spatial filter corresponds to a directional beam that is wider than a directional beam corresponding to a spatial filter of any TCI state in the sequence of TCI states that is representative of that the reference signal is to be transmitted from only one of the TRPs 140a, 140b. For the user equipment 300a, 300b to receive a sufficiently high amount of power, it might thus use a spatial filter corresponding to a wide beam. A TCI state corresponding to a reference signal transmitted in a combination of beamforms could thus indicate to the user equipment 300a, 300b to use such a spatial filter.

The reference signals based on combined beamforms can mix with single-TRP reference signals. This means that each reference signal burst might contain some reference signals transmitted on single-TRPs only and some reference signals on combined beamforms. The maximum number of reference signals in terms of SSBs (maxNrofSSBs) of course needs to be considered. Theoretically, the number of reference signals on combined beamforms does not exceed M·N and this number should be added to the number of single-TRP reference signals (which does not exceed M+N). These two contributions together should add up to a K number not exceeding maxNrofSSBs as stipulated by 3GPP, that is (M·N)+(M+N)≤K. The overhead created by the reference signal burst should also be considered and therefore, the number of reference signal in the burst could be chosen even lower than govern by maxNrofSSBs.

It could be that not all combinations of beamforms make sense. For example, it could be that a beamform Aᵢ from one TRP 140a and a beamform Bᵢ from another TRP 140b diverge to point in different directions such that a user equipment 300a never can be in the focal point of a combination of these beamforms. There could therefore be different ways to determine which reference signals that are to be jointly transmitted from the TRPs 140a, 140b. In some aspects, the combinations are manually configured beforehand so that only reasonable combinations are selected. That is, in some embodiments, which one of the reference signals to be jointly transmitted on beamforms A₁:A_{M} from the first TRP 140a of the TRPs 140a, 140b and beamforms B₁:B_{N} from the second TRP 140b of the TRPs 140a, 140b is configured based on manual input. In other aspects, the combinations are selected based on statistics obtained from measurements in the network. That is, in some embodiments, which one of the reference signals to be jointly transmitted on beamforms A₁:A_{M} from the first TRP 140a of the TRPs 140a, 140b and beamforms B₁:B_{N} from the second TRP 140b of the TRPs 140a, 140b is configured based on statistics obtained from measurements of radio propagation conditions between the TRPs 140a, 140b and the user equipment 300a, 300b. Hence, it is also possible to identify redundant combinations during operation analyzing large sets of CSI reports, comparing RSRP from combined reference signal beamforms with RSRP from single-TRP reference signals. Another option is to use any reception on uplink channels from the user equipment 300a (instead of relying on CSI reports) as a basis for selecting the combinations. In particular, in some embodiments, the network node 200 is configured to perform (optional) step S106:

S106: The network node 200 obtains information of radio propagation conditions between the TRPs 140a, 140b and the user equipment 300a, 300b.

This information could be obtained e.g. from transmissions on a data channel, such as the physical uplink shared channel PUSCH or on a control channel, such as the physical uplink control channel PUCCH or on a random access channel, such as a random access preamble on the physical random access channel PRACH. In some embodiments is the information in step S106 obtained from the user equipment 300a, 300b as feedback reports of the reference signals when having been transmitted in the reference signal burst. In some embodiments is the information in step S106 obtained from uplink measurements of the radio propagation conditions.

If the receptions received (from specific user equipment) over an observation period are related to a subset of beamforms used for (single-TRP) reference signals then the transmissions of reference signals on these beamforms can be combined to form a new reference signal combination in the reference signal burst (possibly replacing another one). In this way the network node 200 can explore what combinations (and even single-TRP reference signals) are useful.

A mapping of reference signals (RS) to beamforms (BF), being either single-TRP beamforms or multi-TRP beamforms, and the corresponding TCI state is shown Table 1. All the reference signals of the burst are indicated by their index (where the index RS runs from 0 to L−1). The notation Ai+Bj shall be understood as the reference signal being transmitted on a combined multi-TRP beam. The notation N/A (short for not applicable) should be understood as a reference signal for this particular RS index is not transmitted at all.

TABLE 1
Mapping between RS index, BF, and TCI state according to a first example

| RS index | RS 0 | RS 1 | RS 2 | RS 3 | RS 4 | . . . | RS L-2 | RS L-1 |
|---|---|---|---|---|---|---|---|---|
| BF | A0 | A1 | N/A | B0 | B1 | . . . | A0 + B0 | A1 + B2 |
| TCI state | 0 | 1 | 2 | 3 | 4 | . . . | L-2 | L-1 |

In some aspects, at least one of the combinations is updated during operation. In particular, in some embodiments, the network node 200 is configured to perform (optional) step S108:

S108: The network node 200 updates, based on the obtained information, which at least one of the TCI states in the sequence of TCI states that is to be representative of one of the reference signals to be jointly transmitted on a beamform A₁:A_{M} from the first TRP 140a of the TRPs 140a, 140b and on a beamform B₁:B_{N} from the second TRP 140b of the TRPs 140a, 140b.

In some aspects, the network node 200 analyzes feedback reports so as to compare RSRP values from any combined beamform with RSRP values from single-TRP beamforms. That is, in some embodiments, the feedback reports comprise RSRP values of the reference signals, and the updating is based on comparing the RSRP values of the reference signals having been transmitted from only one of the TRPs 140a, 140b to RSRP values of the reference signal having been jointly transmitted from the TRPs 140a, 140b.

A reference signal based on combined beamforms can be removed from the reference signal burst, for example if the RSRP from a reference signal transmitted in a combined beamform is never larger than the RSRP from any of the corresponding single-TRP reference signals. These can be considered test single-TRP reference signals. The test single-TRP reference signals can rotate over all the single-TRP beamforms over time. This enables a check to be performed that the combined beamforms should still be used. That is, in some embodiments, a TCI state in the sequence of TCI states is no longer to be representative of the reference signal to be jointly transmitted on a beamform A₁:A_{M} from the first TRP 140a of the TRPs 140a, 140b and on a beamform B₁:B_{N} from the second TRP 140b of the TRPs 140a, 140b when the RSRP values of the reference signal having been jointly transmitted from the TRPs 140a, 140b are not higher than any RSRP value of the reference signals having been transmitted from only one of the TRPs 140a, 140b. One option is to monitor the frequency of potential TCI switching for a user equipment between the test single-TRP reference signals transmitted on a beamform A₁:A_{M} from the first TRP 140a and on a beamform B₁:B_{N} from the second TRP 140b. If potential switching between a pair of beamforms on average for a user equipment ensemble is lower than a frequency threshold then a combined beamform based on this pair of beamforms can be removed.

In Table 2 is shown, compared to Table 1, that the reference signal for RS index RS L−2 was decided not to be transmitted at all (e.g., because of too low reported RSRP from the user equipment 300a). The removed reference signal may be replaced by a reference signal based on a different combination of beamforms or even by a reference signal based on a single-TRP beamform.

TABLE 2
Mapping between RS index, BF, and TCI
state according to a second example

| RS index | RS 0 | RS 1 | RS 2 | RS 3 | RS 4 | . . . | RS L-2 | RS L-1 |
|---|---|---|---|---|---|---|---|---|
| BF | A0 | A1 | N/A | B0 | B1 | . . . | N/A | A1 + B2 |
| TCI state | 0 | 1 | 2 | 3 | 4 | . . . | L-2 | L-1 |

The selection of a new combined beamform (replacing a previous beamform) could be based on that user equipment 300a tends to report preference for only a subset of (single-TRP) beamforms during an observation period. That is, in some embodiments, a TCI state in the sequence of TCI states is to be representative of the reference signal to be jointly transmitted on a beamform A₁:A_{M} from the first TRP 140a of the TRPs 140a, 140b and on a beamform B₁:B_{N} from the second TRP 140b of the TRPs 140a, 140b when, within an observation time window, only a subset of the RSRP values of the reference signals having been transmitted from only one of the TRPs 140a, 140b is above a RSRP threshold value.

In some examples, the frequency of TCI switching between the single-TRP reference signals transmitted on a beamform A₁:A_{M} from the first TRP 140a and on a beamform B₁:B_{N} from the second TRP 140b is monitored. If the switching between a pair of beamforms is higher than a frequency threshold then a combined beamform based on this pair of beamforms can substitute the single-TRPs ones (and they can be removed).

The preferred reference signals could be indicated in CSI reports. The network node 200 could then conclude that individual user equipment 300a could be associated to several (single-TRP) reference signals at the same time if the reported RSRP for the reference signals are more or less the same (meaning that the reference signals had more or less equal RSRP values). Therefore, introducing a combined multi-TRP beamform based on these preferred reference signals would be a reasonable candidate. In Table 3 is shown, compared to Table 2, that the beamform A₁+B₁ is added to the previously non-used RS index RS 2.

TABLE 3
Mapping between RS index, BF, and TCI state according to a third example

| RS index | RS 0 | RS 1 | RS 2 | RS 3 | RS 4 | . . . | RS L-2 | RS L-1 |
|---|---|---|---|---|---|---|---|---|
| BF | A0 | A1 | A1 + B1 | B0 | B1 | . . . | A0 + B0 | A1 + B2 |
| TCI state | 0 | 1 | 2 | 3 | 4 | . . . | L-2 | L-1 |

Another option, compared to Table 3, is to replace an underperforming beam, as shown in Table 4. In Table 4 is shown, compared to Table 2, that the beamform A₁+B₁ replaces the beamform A₁+B₂ for RS index RS L−1.

TABLE 4
Mapping between RS index, BF, and TCI state according to a fourth example

| RS index | RS 0 | RS 1 | RS 2 | RS 3 | RS 4 | . . . | RS L-2 | RS L-1 |
|---|---|---|---|---|---|---|---|---|
| BF | A0 | A1 | N/A | B0 | B1 | . . . | A0 + B0 | A1 + B1 |
| TCI state | 0 | 1 | 2 | 3 | 4 | . . . | L-2 | L-1 |

There could be different points in time when the change of beamforms for transmission of reference signals in the reference signal burst occurs. In some aspects, the change is performed at times of low or no load in order not to affect traffic too much. That is, in some embodiments, the updating in step S108 is performed only when amount of data traffic between the TRPs 140a, 140b and the user equipment 300a, 300b is below a data traffic amount threshold value.

There could be different examples of reference signals that are to be transmitted in the reference signal burst. As previously described, reference signals might be transmitted from either a single TRP 140a, 140b or from a combination of two or more TRPs 140a, 140b.

In some embodiments, each of the reference signals is an SSB. Reference signals in terms of SSBs provide a preliminary reference for the user equipment 300a. In some embodiments, each TCI state in the sequence of TCI states then corresponds to a respective index, as given by an ssb-PositionsInBurst value, in the reference signal burst.

In some embodiments, each of the reference signals is a CSI-RS (or a CSI-RS resource, to be more precise). Reference signals in terms of CSI-RSs convey to the user equipment 300a more accurate information about planned transmissions. In some embodiments, the reference signal burst is then to be transmitted as part of either a beam management process for the user equipment 300a, 300b or a link adaptation process for the user equipment 300a, 300b. The association between TCI state CSI-RS may be conveyed to the user equipment by means of Downlink Control Information (DCI) as signalled on a physical downlink control channel (PDCCH) or indirectly from the TCI of the Control Resource Sets (CORESETs) accommodating the PDCCH. Reference signals in terms of CSI-RSs could either be used for beam management purposes or link adaptation purposes. For beam management purposes, several CSI-RSs, each representing a candidate beamform in a P-2 procedure, can be transmitted from either a single TRP 140a, 140b or from a combination of two or more TRPs 140a, 140b. The different CSI-RS are described by a CSI-RS Resource Indicator (CRI). Given a selected TCI state corresponding to a combined beamform, the CRI would then take the role of TCI state in terms of labelling the beamforms. In some embodiments, each TCI state in the sequence of TCI states then corresponds to a respective sequence of CRIs in the reference signal burst. Some CRIs could then represent single-TRP transmission whilst other CRIs could represent multi-TRP transmission, all within the scope of the previously indicated TCI state. It is also possible to reuse the same CRI at different points in time to differentiate one TRP 140a, 140b or another TRP 140a, 140b or a combination of TRPs 140a, 140b when CSI measurement filtering in the user equipment 300a, 300b is switched off. To obtain the correct channel quality measurement, the network node 200 keeps track of the CSI report received, selects correct measurements for relevant CRI and performs filtering accordingly. For link adaptation purposes, another CSI-RS in a next step can be transmitted according to the beamform (as given by the CRI) selected in the P-2 procedure. This could be used by the user equipment 300a to report channel state information in terms of Rank Indication (RI), Precoding Matrix Indicator (PMI), and Channel Quality Indicator (CQI) to the network node 200. Depending on the selected CRI in the P-2 procedure, the transmission of this CSI-RS again occurs from either a single TRP 140a, 140b or from a combination of two or more TRPs 140a, 140b.

The embodiments disclosed herein could be extended to more than two TRPs 140a, 140b, where thus all TRPs have their own set of beamforms and are controlled by one and the same network node 200.

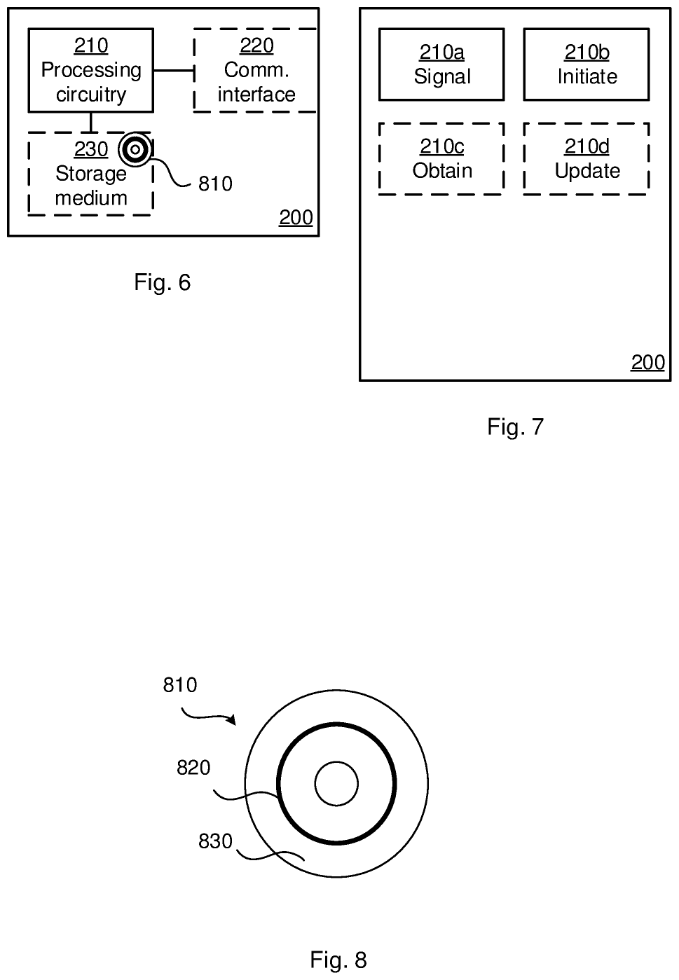

FIG. 6 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 810 (as in FIG. 8), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. In some aspects the processing circuitry 210 implements the functionality of the signal generator 240.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications interface 220 at least configured for communications with other entities, functions, nodes, and devices, for examples as illustrated in FIG. 1 and FIG. 4. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 7 schematically illustrates, in terms of a number of functional modules, the components of a network node 200 according to an embodiment. The network node 200 of FIG. 7 comprises a number of functional modules; a signal module 210a configured to perform step S102, and an initiate module 210b configured to perform step S104. The network node 200 of FIG. 7 may further comprise a number of optional functional modules, such as any of an obtain module 210c configured to perform step S106, and an update module 210d configured to perform step S108. In general terms, each functional module 210a:210d may in one embodiment be implemented only in hardware and in another embodiment with the help of software, i.e., the latter embodiment having computer program instructions stored on the storage medium 230 which when run on the processing circuitry makes the network node 200 perform the corresponding steps mentioned above in conjunction with FIG. 7. It should also be mentioned that even though the modules correspond to parts of a computer program, they do not need to be separate modules therein, but the way in which they are implemented in software is dependent on the programming language used. Preferably, one or more or all functional modules 210a:210d may be implemented by the processing circuitry 210, possibly in cooperation with the communications interface 220 and/or the storage medium 230. The processing circuitry 210 may thus be configured to from the storage medium 230 fetch instructions as provided by a functional module 210a:210d and to execute these instructions, thereby performing any steps as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 6 the processing circuitry 210 may be distributed among a plurality of devices, or nodes. The same applies to the functional modules 210a:210d of FIG. 7 and the computer program 820 of FIG. 8.

FIG. 8 shows one example of a computer program product 810 comprising computer readable storage medium 830. On this computer readable storage medium 830, a computer program 820 can be stored, which computer program 820 can cause the processing circuitry 210 and thereto operatively coupled entities and devices, such as the communications interface 220 and the storage medium 230, to execute methods according to embodiments described herein. The computer program 820 and/or computer program product 810 may thus provide means for performing any steps as herein disclosed.

In the example of FIG. 8, the computer program product 810 is illustrated as an optical disc, such as a CD (compact disc) or a DVD (digital versatile disc) or a Blu-Ray disc. The computer program product 810 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 820 is here schematically shown as a track on the depicted optical disk, the computer program 820 can be stored in any way which is suitable for the computer program product 810.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for signalling TCI states, the method being performed by a network node, the network node being configured to control transmission of reference signals from at least two TRPs, the method comprising:
signalling, towards user equipment being served by the network node, a sequence of TCI states defined for a reference signal burst in which the reference signals are to be transmitted from the TRPs, wherein at least one of the TCI states in the sequence of TCI states is representative of one of the reference signals to be jointly transmitted on a beamform from a first TRP of the TRPs and on a beamform from a second TRP of the TRPs; and
initiating transmission of the reference signal burst from the TRPs.

2. The method according to claim 1, wherein the reference signals in the reference signal burst from each of the TRPs are transmitted during a beam sweep performed in a set of beamforms, and wherein in each beam sweep the reference signals are sequentially transmitted, one reference signal per beamform in the set of beamforms.

3. The method according to claim 1, wherein at least one of the TCI states in the sequence of TCI states is representative of that one of the reference signals is to be transmitted from only one of the TRPs.

4. The method according to claim 1, wherein which one of the reference signals to be jointly transmitted on beamforms from the first TRP of the TRPs and beamforms from the second TRP of the TRPs is configured based on manual input.

5. The method according to claim 1, wherein which one of the reference signals to be jointly transmitted on beamforms from the first TRP of the TRPs and beamforms from the second TRP of the TRPs is configured based on statistics obtained from measurements of radio propagation conditions between the TRPs and the user equipment.

6. The method according to claim 1, wherein the method further comprises:
obtaining information of radio propagation conditions between the TRPs and the user equipment.

7. The method according to claim 6, wherein the information is obtained from the user equipment as feedback reports of the reference signals when having been transmitted in the reference signal burst.

8. The method according to claim 6, wherein the information is obtained from uplink measurements of the radio propagation conditions.

9. The method according to claim 6, wherein the method further comprises:
updating, based on the obtained information, which at least one of the TCI states in the sequence of TCI states that is to be representative of one of the reference signals to be jointly transmitted on a beamform from the first TRP of the TRPs and on a beamform from the second TRP of the TRPs.

10. The method according to claim 9, wherein the feedback reports comprise reference signal received power, RSRP, values of the reference signals, and wherein the updating is based on comparing the RSRP values of the reference signals having been transmitted from only one of the TRPs to RSRP values of said one of the reference signals having been jointly transmitted from the TRPs.

11. The method according to claim 10, wherein a TCI state in the sequence of TCI states is no longer to be representative of said one of the reference signals to be jointly transmitted on a beamform from the first TRP of the TRPs and on a beamform from the second TRP of the TRPs when the RSRP values of said one of the reference signals having been jointly transmitted from the TRPs are not higher than any RSRP value of the reference signals having been transmitted from only one of the TRPs.

12. The method according to claim 10, wherein a TCI state in the sequence of TCI states is to be representative of said one of the reference signals to be jointly transmitted on a beamform from the first TRP of the TRPs and on a beamform from the second TRP of the TRPs when, within an observation time window, only a subset of the RSRP values of the reference signals having been transmitted from only one of the TRPs is above a RSRP threshold value.

13. The method according to claim 9, wherein said updating is performed only when amount of data traffic between the TRPs and the user equipment is below a data traffic amount threshold value.

14. The method according to claim 1, wherein the sequence of TCI states represents a sequence of spatial filters to be used by user equipment for reception of the reference signals.

15. The method according to claim 1, wherein each spatial filter corresponds to a directional beam, and wherein said at least one of the TCI states in the sequence of TCI states that is representative of said one of the reference signals to be jointly transmitted on the beamform from the first TRP of the TRPs and on the beamform from the second TRP of the TRPs represents a spatial filter corresponding to a directional beam that is wider than a directional beam corresponding to a spatial filter of any TCI state in the sequence of TCI states that is representative of that the reference signal is to be transmitted from only one of the TRPs.

16. The method according to claim 1, wherein each of the reference signals is a synchronization signal burst, SSB.

17. The method according to claim 16, wherein each TCI state in the sequence of TCI states corresponds to a respective index, as given by an ssb-PositionsInBurst value, in the reference signal burst.

18. The method according to claim 1, wherein each of the reference signals is a channel state information reference signal, CSI-RS.

19. The method according to claim 18, wherein the reference signal burst is to be transmitted as part of either a beam management process for the user equipment, or one of the reference signals of the burst is to be transmitted as part of a link adaptation process for the user equipment.

20. The method according to claim 19, wherein each TCI state in the sequence of TCI states corresponds to a respective sequence of channel state information reference signal resource indicators, CRIs, in the reference signal burst.

21.-25. (canceled)
